(19) United States
(12) Patent Application Publication
(10) Pub. No.: US 2006/0045680 A1
(43) Pub. Date: Mar. 2, 2006

(54) Method, apparatus and system for manufacturing containers, such as rotationally-molded noise-dampening containers

(75) Inventors: John d'Arc Lorenz, Vancouver, WA (US); Robert J. Berres JR., Gig Harbor, WA (US); Troy T. Johnson, Portland, OR (US)

Correspondence Address: SEED INTELLECTUAL PROPERTY LAW GROUP PLLC, 701 FIFTH AVE, SUITE 6300, SEATTLE, WA, 98104-7092, US

(73) Assignee: American Container and Recycling, Incorporated, Vancouver, WA (US)

(21) Appl. No.: 11/104,390

(22) Filed: Apr. 12, 2005

Related U.S. Application Data
(60) Provisional application No. 60/561,559, filed on Apr. 12, 2004.

(51) Int. Cl. B65F 3/02

(52) U.S. Cl. 414/408

(57) ABSTRACT

A method, apparatus and system for manufacturing containers, such as rotationally-molded noise-dampening containers. The containers may be made of linear low-density polyethylene (LLDPE) with a unique structural configuration to provide a low maintenance, noise-dampening, impact and dent resistant, durable, strong and rust proof container. The bottom of the container optionally includes strengthening bars positioned within molded grooves to provide an additionally reinforced bottom panel of the container. A nut may be molded in place during the rotational molding process to connect to a caster plate thereto and thus provide an integral leak-proof connection to the wheel assembly.

### BACKGROUND OF THE INVENTION

1. Field of the Invention

The present invention relates generally to the field of refuse containers, and more particularly to methods, apparatus and systems for providing refuse containers and hauling systems that reduce noise during unloading of such containers.

2. Description of the Related Art

Presently, commercial sized refuse containers are constructed from steel, and come in a variety of sizes, the most prevalent being 3 and 4 cubic yard sizes. Early advancements in the art of refuse handling included the adaptation of such containers to be handled by lifting equipment. In particular, refuse containers were fitted with fork pockets so as to receive adjustable fork assemblies mounted to mobile refuse collection vehicles. By utilizing collection vehicles equipped with lifting forks, and servicing containers fitted with fork pockets, significant gains in speed, safety, and efficiency have been realized. However, an unintended consequence has been the noise resulting from the engagement of the container by the forks as well as by the removal of refuse from the container when shaken (as is often times the case) to ensure that all debris has been removed.

A principal reason for the significant noise emanating from the container is the fact that the container is nearly always a hollow steel structure. Operational noises from both the vehicle and the container during refuse removal are amplified by the volume defined by the container. Steel is used because steel provides strength benefits that have not been previously duplicated in alternative materials.

In addition to the noise pollution generated by the steel containers, steel containers also dent and rust, requiring significant maintenance expenditures and eventually requiring them to be prematurely replaced. For example, if a steel container is not repainted on an annual basis, portions of the container may rust, causing the lifespan of the container to be significantly and prematurely shortened.

### BRIEF SUMMARY OF THE INVENTION

The invention is directed toward a refuse container that reduces noise while having a high strength to weight ratio. The container of the present invention combines strength and durability, and is a lighter weight container that is nearly maintenance free. The containers may also be stackable for saving shipping costs and for space-efficient storage.

The container may further include a sleeve for the fork of a forklift, the sleeve being formed from, or having a liner formed from, a vibration absorbing material. The liner may be integral with the sleeve or may be for insertion into a pocket associated with a container. The sleeve, liner and container is preferably constructed from a durable material having very low vibration transmission properties and/or high damping properties.

According to one aspect of the invention, the containers may be made of a vibration absorbing material such as linear low-density polyethylene (LLDPE), and further includes a unique structural configuration to provide a low maintenance, noise-dampening, impact and dent resistant, durable, strong and rust proof container. According to aspects of the invention, the bottom of the container includes ribs or grooves configured to receive strengthening bars positioned within the pre-molded grooves to provide an additionally reinforced bottom panel of the container or alternatively to contain molded in place strengthening members in the bottom.

In one embodiment, the container is a rotationally molded, polyethylene body.

According to further aspects of the invention, a nut or other fastener is molded in place during the rotational molding process to allow caster plates to be mounted without breaching the integrity of the container bottom, thus providing an integral leak-proof connection.

### BRIEF DESCRIPTION OF THE DRAWINGS

FIG. 1 is a front isometric view of the refuse container in accordance with aspects of the present invention.

FIG. 2A is a plan view of the back of the refuse container of FIG. 1 in accordance with aspects of the present invention.

FIG. 2B is a cross-section taken along lines 2B-2B from FIG. 2A.

FIG. 3 is a side plan view of the refuse container of FIG. 1 in accordance with aspects of the present invention.

FIG. 4 is a side plan view of other side of the refuse container of FIG. 1 in accordance with aspects of the present invention.

FIG. 5 is a plan view of the top of a refuse container with a closed lid in accordance with aspects of the present invention.

FIG. 6 is a plan view of the front of a refuse container in accordance with aspects of the present invention.

FIG. 7 is a plan view of the bottom of a refuse container in accordance with aspects of the present invention.

FIG. 8 is plan view of the front of an exemplary 6 cubic yard refuse container in accordance with aspects of the present invention

FIG. 9 is a plan view of the side of the exemplary 6 cubic yard refuse container in accordance with aspects of the present invention.

FIG. 10 is a cross-sectional view along 10-10 of the exemplary 6 cubic yard refuse container of FIG. 9.

FIG. 11 is an enlarged cross-sectional view of the lip of the exemplary 6 cubic yard refuse container of FIG. 9.

FIG. 12 is a plan view of the bottom of the exemplary 6 cubic yard refuse container in accordance with aspects of the present invention.

FIGS. 13A-13C are yet another embodiment of the present invention illustrating a fluorescent lamp disposal container in accordance with principles of the present invention.

FIG. 14 is a plan rear view of a latching device for the fluorescent lamp disposal container of FIGS. 13A-13C.

FIG. 15 is a plan side view of a tether chain device for the fluorescent lamp disposal container of FIGS. 13A-13C.

FIG. 16 is an alternative embodiment of a refuse container preferably one that can be used for newspaper recycle.

In the drawings, identical reference numbers identify similar elements or acts. The sizes and relative positions of elements in the drawings are not necessarily drawn to scale. For example, the shapes of various elements and angles are not drawn to scale, and some of these elements are enlarged and positioned to improve drawing legibility.

### DETAILED DESCRIPTION OF THE PREFERRED EMBODIMENTS

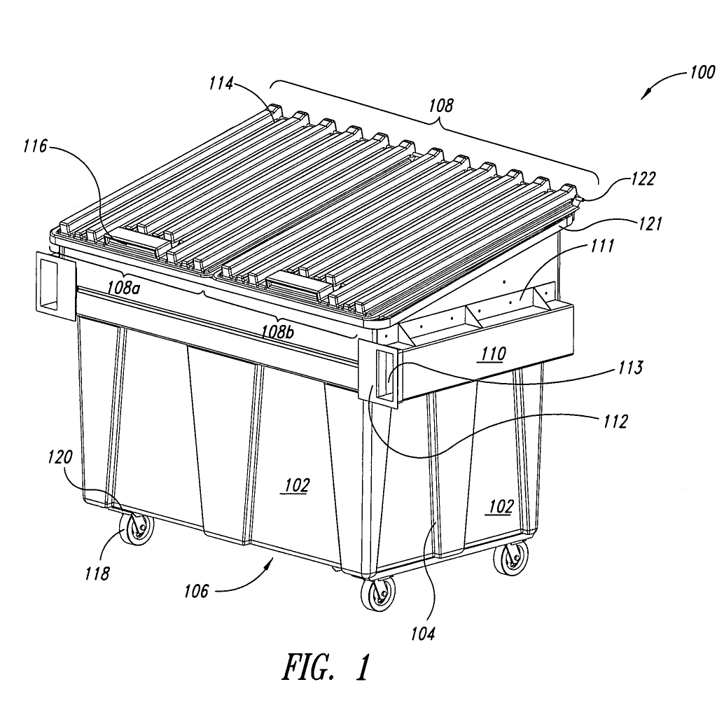

FIG. 1 is a front isometric view of a refuse container 100 sized for the collection of refuse from commercial businesses. The refuse container 100 may be 2 cubic yard (cy), 3 cy, 4 cy, 5 cy, 6 cy or any other commercial dumpster size. The refuse container of this embodiment has an integrally formed bottom 106 and sidewalls 102. The refuse container 100 further includes wheels 118 mounted on caster plates 120, the wheels being mounted near each corner on the bottom 106 of the refuse container 100.

For use during loading and unloading, the container 100 further includes a sleeve assembly 110 having an aperture 113 for receiving a fork from a fork lift (not shown). The sleeve assembly 110 has a connection means 111 for removably connecting to the container 100, shown as an angle bolted to the container 100 in the present embodiment. Alternatively, the sleeve assembly 110 may be integrally formed with the container 100. The sleeve assembly 110 may also include a face plate 112 around an aperture 113 to protect the container 100 from an end of a fork when the fork is mating up to the sleeve aperture 113.

The sidewalls 102 of this embodiment include recessed or stepped 104 panels to provide the container 100 with additional flexure strength when full of refuse or during loading and unloading operations. Alternatively, the sidewalls may include corrugations or ribbing to provide rigidity and flexural support.

The container 100 further includes a lid 108 having corrugations 114 and handles 116 integral thereof. The container 100 and the lid 108 are preferably rotationally molded of a hardened plastic, for example, a linear low-density polyethylene (LLDPE) or a cross-linked polyethylene. Strength testing confirms that the rotationally molded containers have increased advantages over similar steel or injection-molded containers, including, strength, durability, and noise mitigation.

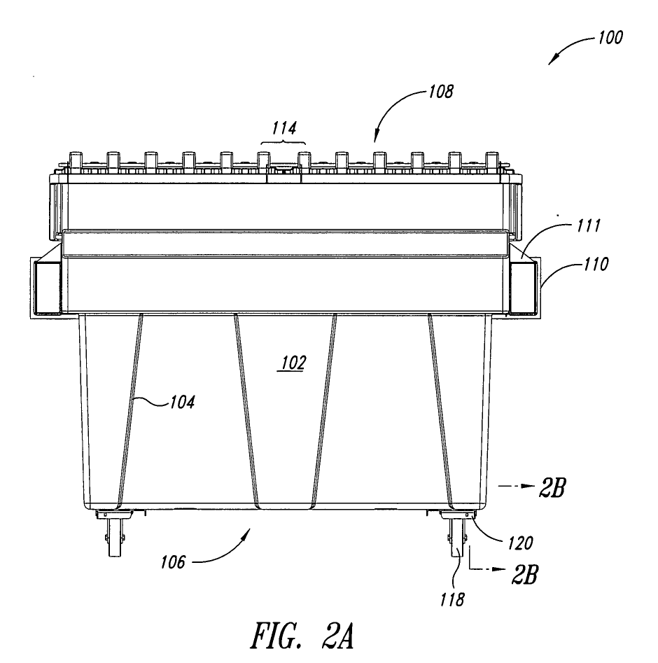

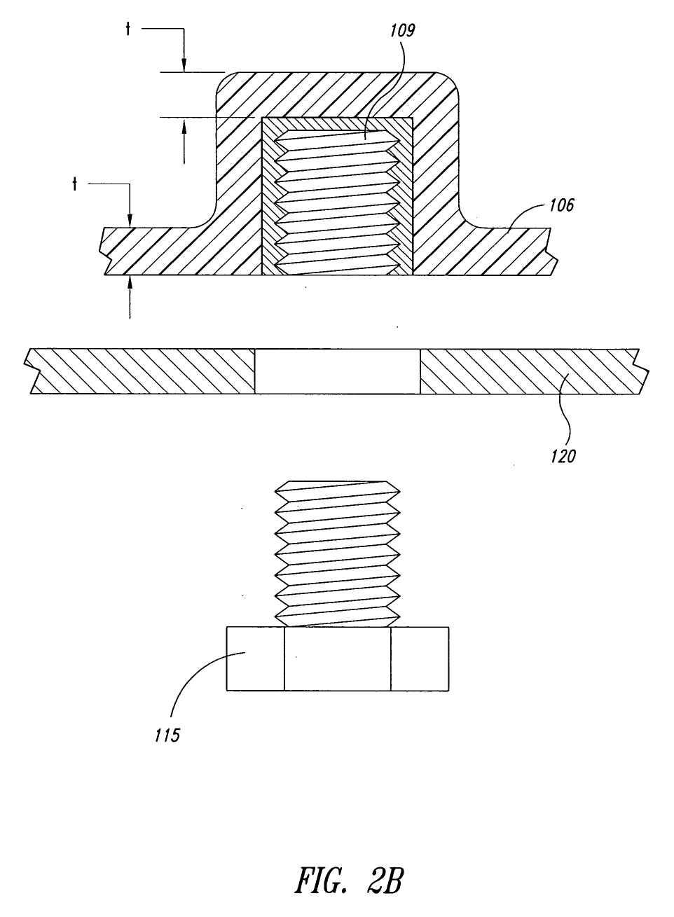

The individual components of the refuse container 100 will now be discussed in detail. As used herein, “rear” refers to the side of the container 100 on which the hinge assembly is mounted as shown in FIG. 2A or to which it is the closest, such as rear wall 903 shown in FIG. 9. The terms “front” and “sides” are used in reference to the term “rear” as defined.

Referring to FIG. 1, the lid 108 of the exemplary embodiment comprises a generally flat cover portion that includes corrugations 114, ribs, or panels and is sufficiently sized to cover the container body opening. A vertical peripheral skirt 121 extends over the container body collar (not shown). The lid 108 in combination with the skirt 121 covers the container body to shield the contents of the interior cavity from the environment.

The lid 108 includes a handle 116 which is positioned at a front edge of the covered portion. The lid 108 shown in FIG. 1 is split into two separate portions 108a, 108b to allow half of the container to be opened at one time. Both portions 108a, 108b of the lid share the same hinge pin assembly 122. The ribbed lid 108 of the exemplary embodiment may include an e-coated metal hinge pin with stainless fasteners. The ribbed design of the lid provides additional strength as well as rapid water deflection.

FIG. 2A shows a rear plan view of the container 100. The container 100 includes the lid 108 having corrugations 114, a closed end of the lifting sleeve 110 affixed to a side 102 of the container 100 by the mounting plate 111. The sides of the container 100 include recessed panels. The step 104 or corrugation defining the panels provide additional rigidity and flexural strength to the sides 102 of the container 100. As shown in the present embodiment, the step 104 or corrugation is at an angle greater than vertical or less than vertical, wherein each step is alternating between an angle great than vertical with the next step having an angle less than vertical, and so on. Although four steps 104 or corrugations are shown on the rear side panel in FIG. 2A, it is understood that more or fewer or no steps could be included in the side panels of the container.

FIGS. 1 through 7 illustrate the refuse container as having nuts 109 for the caster plates 120 integrally molded into a bottom 106 of the container body. A lug nut 109 (see FIG. 2B) is integrally retained within the bottom 106 during the rotational molding of the container 100. Caster plates 120 are affixed to the lug nut and wheels 118 are mounted to the caster plate 120. The wheels 118 are disposed on opposite sides of the container body 100 on the front and rear side, in each corner of the container 100. The wheels are sufficiently sized to support the refuse container. According to aspects of an alternative embodiment, a wheel axle may extend through an aperture in the container bottom to support the wheels or may be affixed by alternative means as is known in the art.

FIG. 2B shows the cross-sectional view from 2A with the embedded lug nut 109. The bottom 106 of the container 100 is a single contiguous, integral piece. In a preferred embodiment, there are no apertures, protrusions or bolts that extend through the bottom 106 of the container. Namely, it is a solid bottom 106 without through-holes. This ensures that the bottom is completely watertight. It also provides the advantage that there will be no enlarging of apertures by flexing, which could extending through the bottom which substantially increase the life of the container. In order to bolt the castor plate 120 to the bottom of the container 100, a metal inset such as a bolt or threaded screw is integrally molded into the bottom of the container 106, as shown in FIG. 2B. In particular, the bottom 106 has integrally molded into it a metal nut or other insert 109 which does not penetrate through the plastic bottom. This ensures that the metal insert is completely surrounded by at least the same thickness t of material as the thickness t of the bottom 106 itself. This provides a slight upstanding plastic mound in the bottom of the container 100. However, the bottom of the container is still one continuous plastic piece so that there are no through-holes through the container. As shown in FIG. 2B, the castor plate 120 is bolted onto the bottom 106 via a bolt 115. The bolt 115 has a height such that it clamps the castor plate 120 tightly to the bottom 106 without hitting the very bottom of the metal insert 109. Thus, the length of the bolt 115 is made shorter than the depth of the metal insert or lug nut 109 to ensure sufficient play for tightening of the castor plate 120 against the bottom 106.

Integrally retaining the lug nut 109 during the rotational molding process allows the wheel assembly to be secured to the bottom panel 106 of the container 100 without compromising the integrity of the bottom panel 106 of the container 100. Bolts and other fixation devices create weak spots in the container and were traditionally the source of cracking and damage to the integrity of the container. According to aspects of the present invention, no thru-bolt is required in the bottom of the container, thus allowing the bottom to remain intact and the integrity uncompromised.

According to aspects of the invention, the caster assembly may include a molded-in deck mounting bolts or nut of e-coated, formed in 7 gauge solid steel in order to provide a leak-proof connection. Alternatively, all metal parts may be black powder coated. In one exemplary embodiment, the casters are 6″ solid rubber wheels with external grease fittings. Alternative embodiments include wheels as are known in the art.

In an alternative embodiment, wooden skid plates are used instead of castors. In a large container, such as a 7 cubic yard container or 6 cubic yard container, it is not expected that the containers will be rolled because of their extensive weight when full. For such containers, the castors are replaced by large metal bars or wooden skids which run the length of the castor plate 120 and support the container 100 sufficient distance off the ground that a forklift may get underneath the container to lift it for dumping.

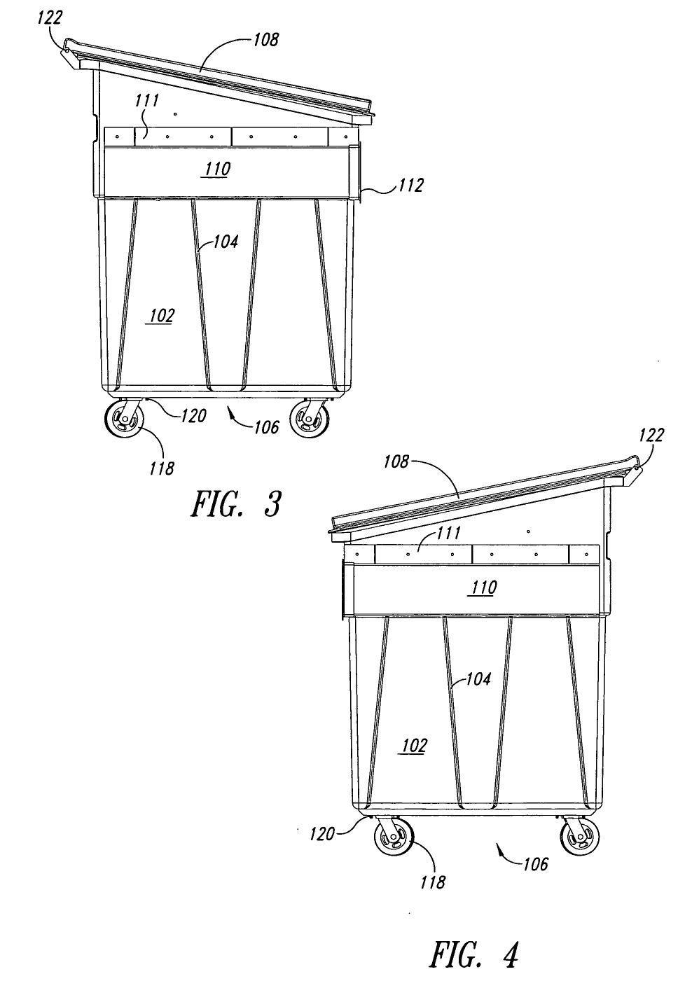

FIGS. 3 and 4 illustrate a left and right side plan view of the container 100. The sides 102 are shown to be generally symmetrical, each side having a stepped 104 or corrugated side panel to provide additional rigidity and flexural strength to the side panel. From the side view, it is easily seen that the lid 108 rotates pivotally around a hinge pin 122. Alternatively, fasteners as are known in the art may be used to secure the lid to the container, or the lid may act as a cover and may not be fastened to the container.

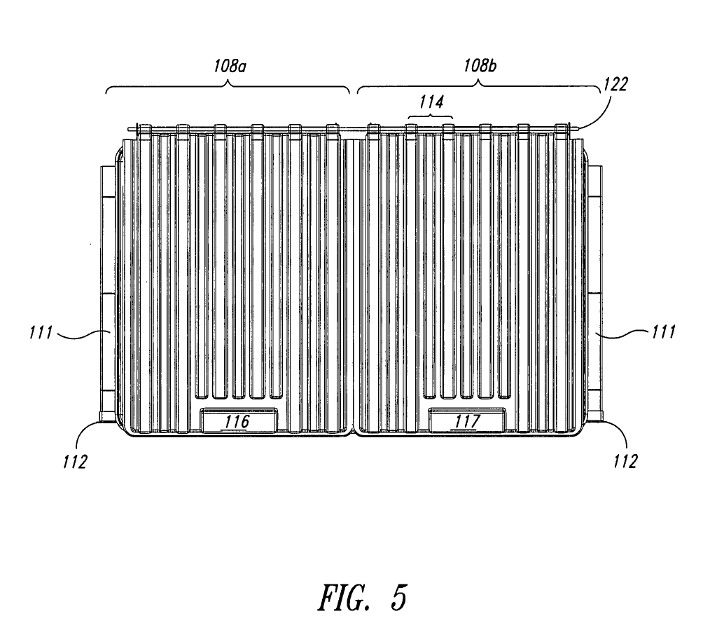

FIG. 5 is a plan view of a lid 108 of the container 100. The lid 108 of this embodiment is split into two separate sections 108a, 108b, such that each section may be opened independent of the other. Each section includes a handle 116, 117 for opening and closing the respective section 108a, 108b of the lid 108. It is understood that there may be more or fewer or no lid sections. The two lid sections 108a, 108b of the illustrative embodiment are connected to the container via a common hinge pin 122. Alternatively, each lid section may be separately affixed to the container. Additionally, a variety of known fasteners may be used to attach the lid sections to the container including but not limited to a piano hinge, clamps, brackets and the like as is known in the art.

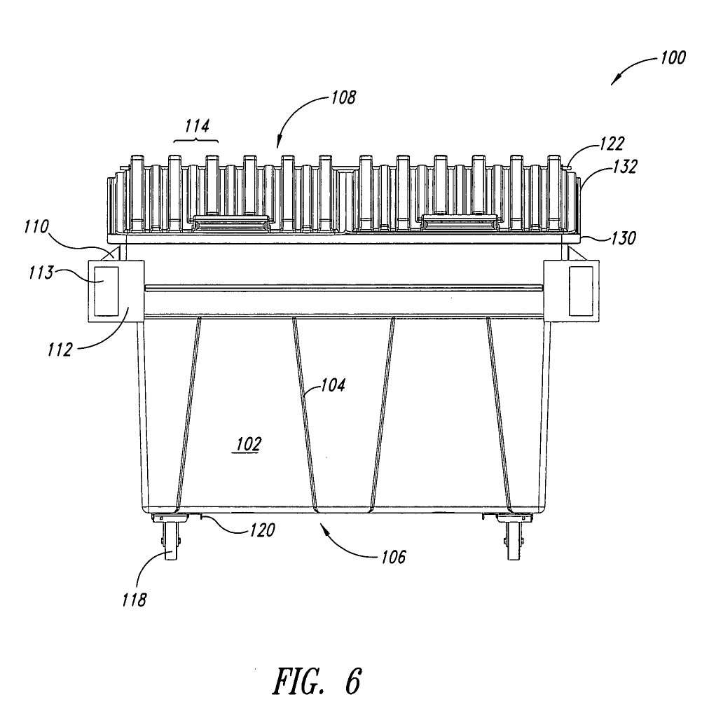

FIG. 6 is a front plan view of the container 100. From the front, back and side views taken together, it is shown in the exemplary embodiment that the lid 108 is angled downward from a back edge 132 of the container 100 to a front edge 130 of the container 100. Angling the lid 108 facilitates rainwater runoff. Further, providing a lower front edge 130 of the container 100 compared with a back edge 132 of the container 100 further facilitates ease of loading the container 100.

FIG. 6 further illustrates the face plate 112 on the lift pockets or sleeve 110. The face plate 112 provides protection to the front of the container 100, providing a buffer and preventing damage by the forks when lifting the container. The sleeve 110 contains a hollow passage 113 for receiving the lifting forks of a forklift or other lifting equipment. The lift pockets or sleeve 110 shown in FIGS. 1 through 7 may be e-coated, 10 gauge formed solid steel plates integral to the container. Alternatively, the lift pockets or sleeve 110 may be the same vibration absorbing material used to manufacture the container and may be separately affixed by attaching the mounting plate 111 to the container 100 with acceptable fasteners. Alternatively, the sleeves 110 are integrally formed with the container in the rotational molding process.

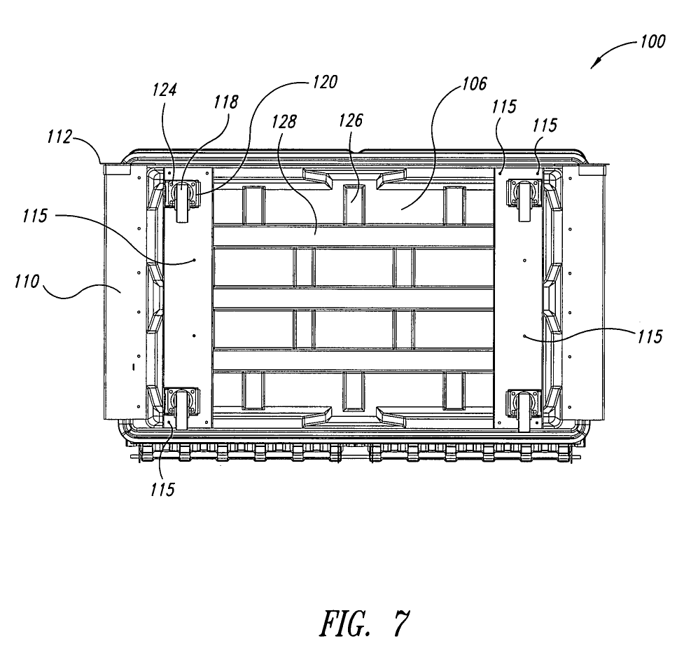

FIG. 7 is a plan view of the bottom 106 of the container 100. The bottom panel 106 of the container 100 of the present embodiment includes molded-in cross ribbing 126, 128 for added strength. The cross ribbing 126, 128 can include shorter lateral ribs 126 between longer continuous transverse ribs 128. Alternatively the lateral ribs may be continuous and the transverse ribs may be positioned there between. According to one embodiment, the cross ribbing 126, 128 is formed during rotational molding and comprises thickened polyethylene sections or raised corrugations of different heights.

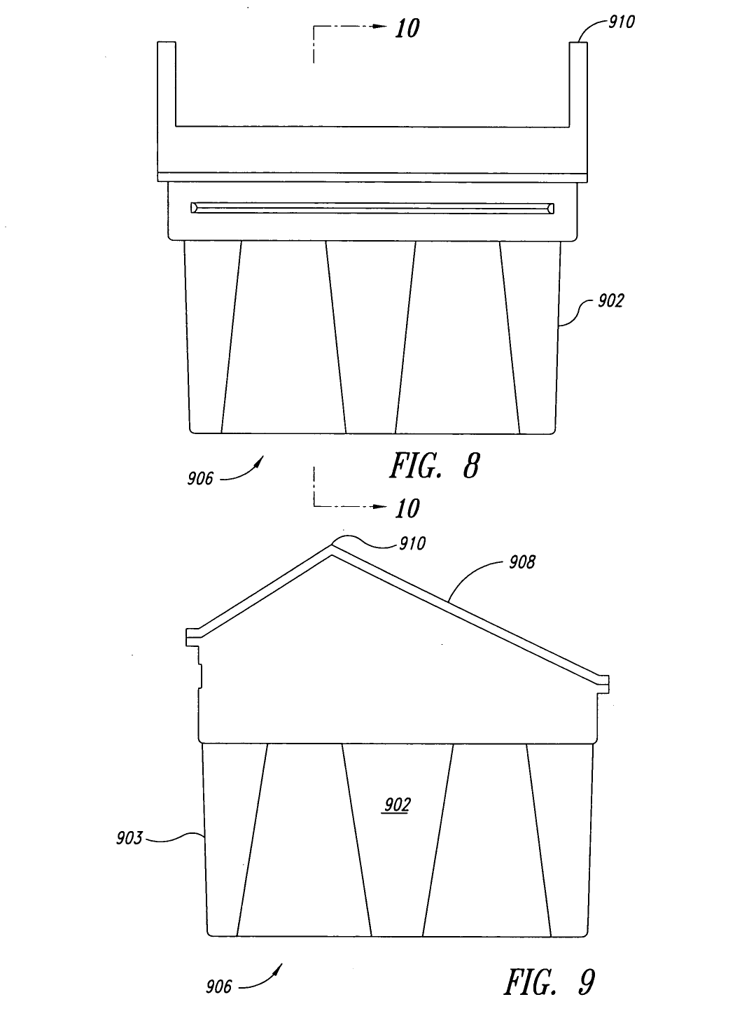

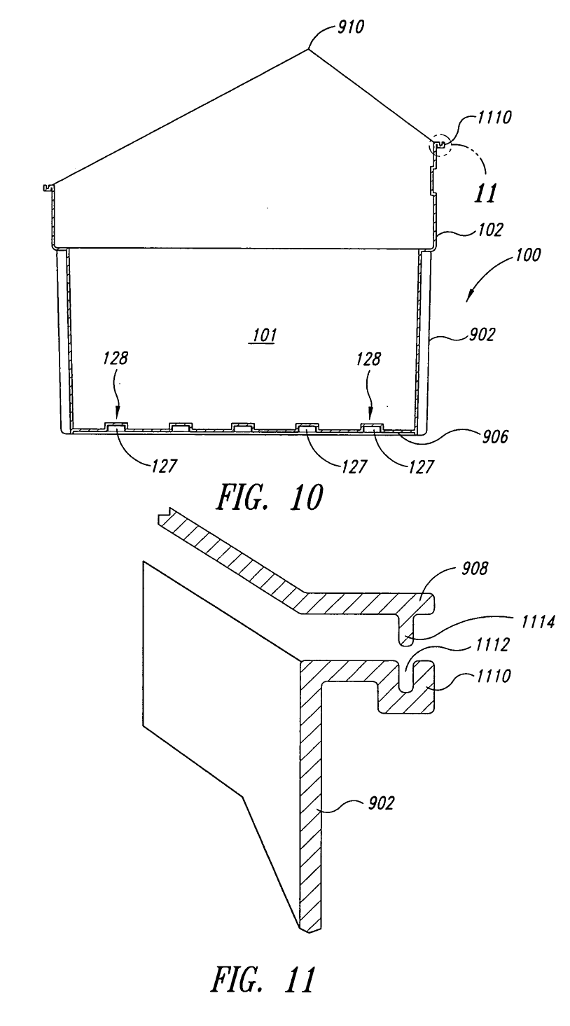

The ribs 128 are raised corrugations in the bottom of the container 128. This type of corrugation can be seen in cross-section in FIG. 10.

According to one embodiment, the transverse ribs 128 are two or three times the depth of the lateral ribs 126. In one embodiment, the transverse ribs 128 are 1.5 inches deep and the lateral ribs 126 are 0.5 inch deep. This provides substantial structure advantages. The difference in height of the ribs provides a three-tiered bottom that avoids buckling or flexing.

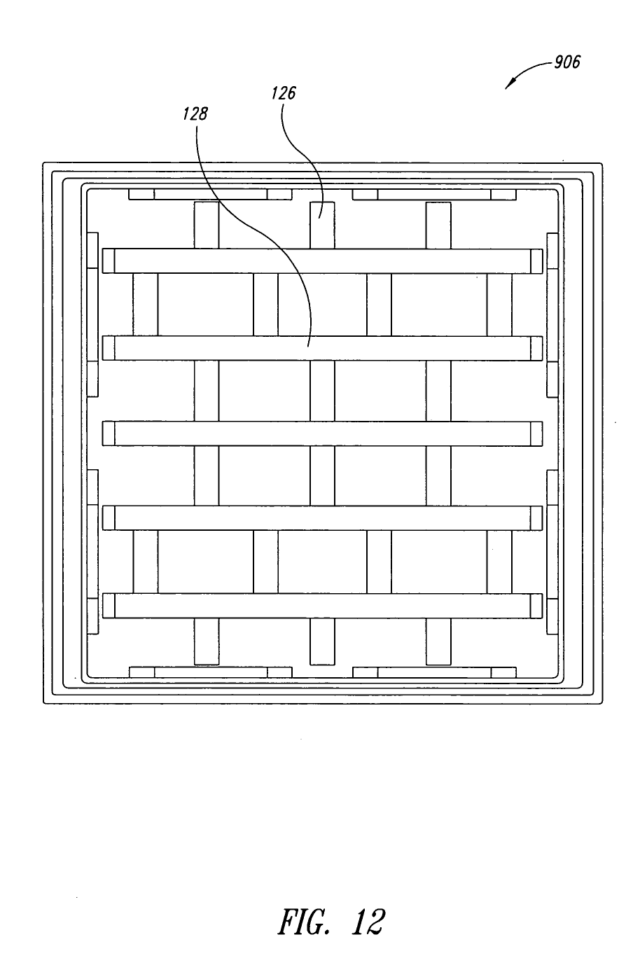

According to yet another alternative embodiment, the continuous transverse ribs are hollow pockets able to receive strengthening inserts such as wood pieces, metal straps or rods, and the like. Namely, a metal strap 127 or wood bar is placed inside ribs 128 and is affixed to the container 100 or to the castor plate 120. This fills the rib 128 with a strong material and provides further resistance to flexing or bending. According to yet another embodiment of the invention, the lateral ribs may also be hollow pockets for receiving strengthening inserts prior placing the container in use. As shown in FIGS. 7 and 12, the bottom of the container may contain pre-molded insets to receive strengthening bars 127. These bars 127 may be recycled wood, plastic or steel and may be inserted at the time of manufacture or may be inserted at a later time. These bars provide additional reinforcing strength, thus allowing the container to hold heavier loads while maintaining structural integrity.

In yet another embodiment, a strengthening member 127 is integrally formed substantially simultaneous with the rotational molding of the container. In an alternative embodiment, the strengthening member is inserted into preformed pockets after the container is full formed.

FIGS. 8 and 9 show an alternative container configuration. This alternative embodiment is similar in many ways to previously described embodiments, and common acts and structures are identified by the same reference numbers. Only significant differences in operation and structure are described below. FIGS. 8 and 9 illustrate an alternative design for a larger container, for example, for a 6 or 7 cubic yard container. The container of FIGS. 8 and 9 includes a lid 908 having an apex 910. The lid 908 is supported by a sidewall 902 configuration having a supporting apex design. The apex lid 908 permits rapid runoff of rain in a forward and rearward direction. The apex lid 908 further allows a greater interior cavity volume in the container 900 for refuse. Additionally, the apex lid 908 of FIG. 9 provides additional stability for the lid such that the two-piece lid is not as flexible or floppy when opened or closed as would be a similarly sized single lid of a flat configuration to cover the entire top. The angle at the apex 910 can be selected to have a desired angle, either flat or steep.

FIG. 16 illustrates yet another alternative embodiment of a large container having an apex 910. According to this embodiment, a rear portion 907 is rigidly affixed to the container and is not opened and thus does not act as a lid. The front portion is generally flat and has a lid connected at the apex 910. On the front of the container is a bar 913 which can be used to lock the lid in position to keep it from flying open during windstorms or which may be secured by padlock to prevent people from getting inside the container and removing the contents thereof without authorization. The embodiment of 16 also includes rectangular openings 133 in the front face thereof so that when the lid is closed, material may be thrown into the container such as newspapers wrapped in bundles. The size of the apertures is selected to fit a bundle of newspapers, such a container being ideal for newspaper recycling purposes.

FIG. 16 is one embodiment which is useful for newspaper recycle. It may be a large container, such as 7 cy. It contains a lid latch 913 which can close on top of a lid, which is not shown in FIG. 16, but similar to that shown in other figures. The large container includes cut outs 133 so that material, such as newspaper bundles, may be deposited therein with the lid closed.

The lid latch 913 is a bar mounted to a pivot at each end and that extends across the front lip of the lid. It can be rotated down to open the locked lid or up to hold it shut. It can be shut with a padlock or other secure structure to keep anyone without a key from opening the container to remove the material to be recycled, such as newspapers or metal, which may have a street value. A user may deposit material in the cut out slots 133, but these are too small for a person to enter or reach in to remove the contents, so that as the container begins to be filled with the material to be recycled, it can only be removed by an authorized person. The input slot 133 is therefore open at all times and separate from the removal opening, which is in a large opening under a top lid using a fork lift or dump truck with a lift.

FIG. 10 is a cross sectional view along line 10-10 of FIG. 8. Transverse pockets 128 are shown prior to placement of strengthening inserts. Also shown is a collar 1110 at the top of a sidewall 902.

As illustrated in FIG. 11, at the top of the refuse container 100 the sidewall 102 terminates in a collar 1110 defining an opening 1112 which opens into the hollow interior cavity 101 of the container body 900. The collar 1110 mates with the underside of the lid 108, 908 along the front and side edges to provide a seal from, for example, moisture and odors, shown in exploded view in FIG. 11.

FIG. 12 illustrates yet another embodiment of a bottom panel 906 of the container 900. Lateral ribs 126 and transverse ribs 128 provide additional strengthening for the container 900 when loaded and during the loading and unloading process. Although a defined number of lateral and transverse ribs are shown in FIG. 12, it is understood that more or less or no ribs may be provided in accordance with aspects of this invention. Further, although the ribs are shown to be generally linear, the ribs are not restricted to a linear configuration and may be of any known shape. Further, as discussed above, the lateral ribs and/or the transverse ribs may be continuous or discontinuous, may be of different heights, may be thickened solid sections or may be hollow pockets configured to receive strengthening members either at the time of molding or after the container has been molded.

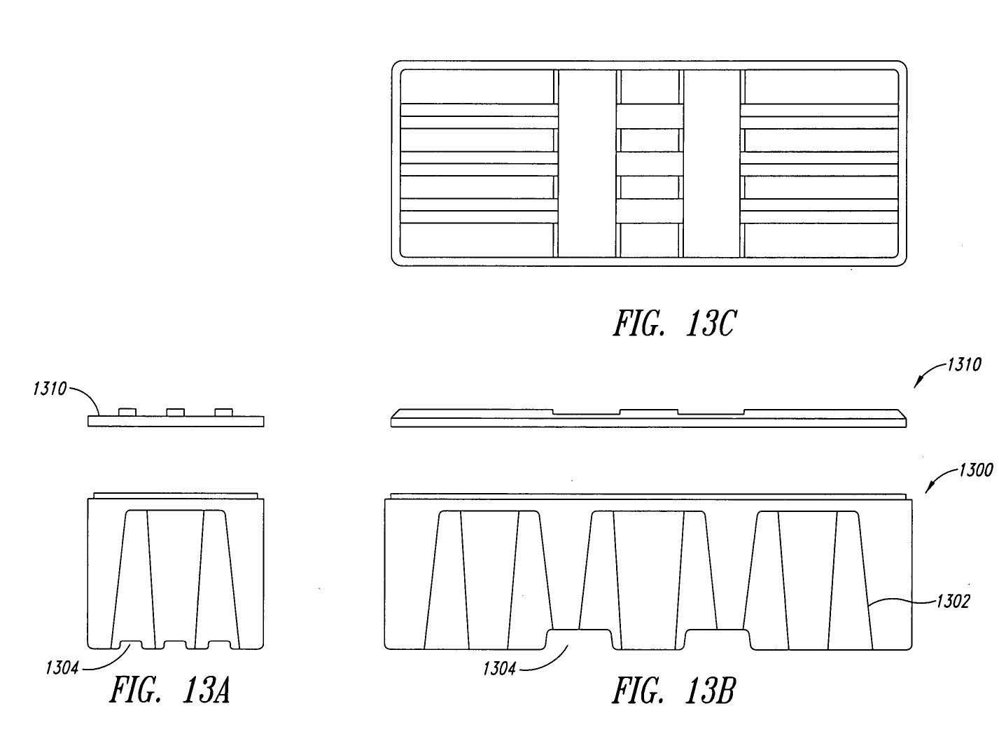

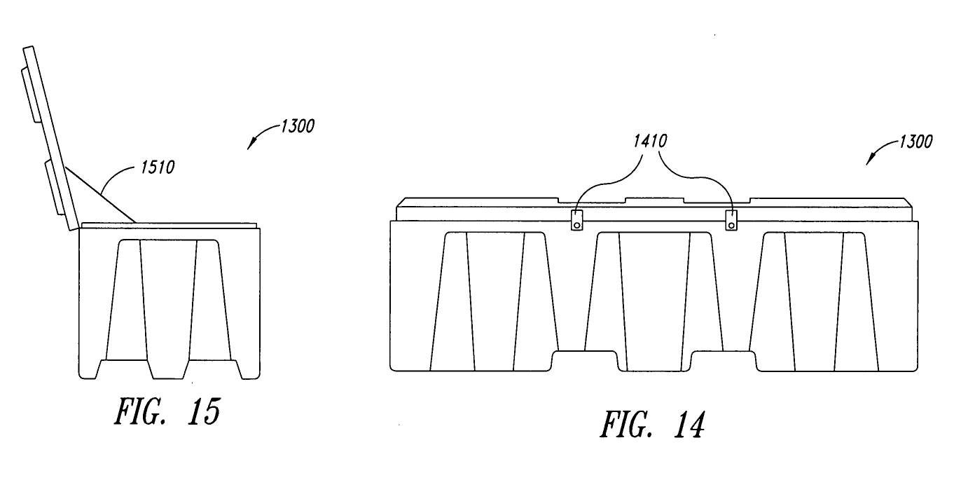

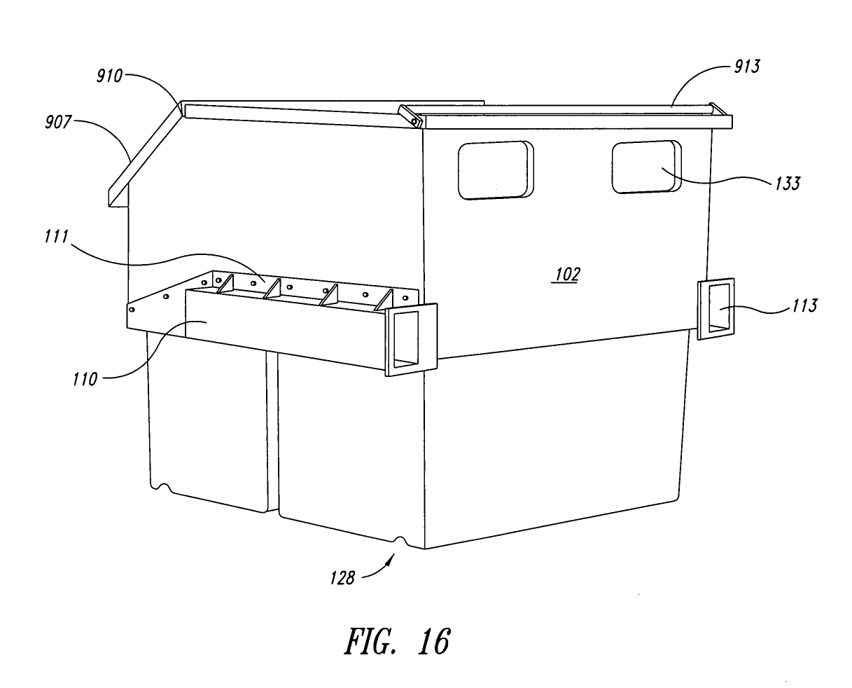

FIGS. 13A, 13B and 13C illustrate yet another embodiment of the present invention, namely, a fluorescent lamp disposal containment box 1300. Fluorescent lights are considered hazardous waste and as such must be disposed of in a prescribed manner. Typically, old fluorescent light bulbs are slid into the cardboard packaging of the replacement light bulb for ease of disposal. Unfortunately, the cardboard packaging provides no insulation and little containment in the event that the fluorescent light bulb is broken. FIGS. 13A, 13B and 13C illustrate a specially sized containment box 1300 for disposing of used fluorescent light bulbs. The containment box 1300 includes many of the features that provide for an improved refuse container, including recessed side panels 1302, lateral and transverse ribs 1304 in the bottom panel, and leak-proof, rust-proof manufacturing. Additionally, the containment box 1300 includes a stacking lid 1310. As shown in FIG. 14, the containment box 1300 may further contain latching hasps 1410, piano hinges or other fasteners known in the art. FIG. 15, for example, illustrates an additional component, namely, a tether chain 1510 to allow the lid to open to a specified angle, for example, 110 degrees, for ease of loading and unloading of the containment box 1300.

Many of the embodiments and configurations disclosed above may be interchanged to create alternative embodiments under principles of the present invention. For example, in one embodiment, ultra high molecular weight (UHMW) polyethylene is chosen as the vibration absorbing material, in an alternative embodiment, linear low-density polyethylene (LLDPE) is used for the vibration absorbing material. However, it is to be noted that the invention includes metallic, non-metallic, and hybrid materials, with the ultimate selection criteria resulting in a reduction in vibration transmission between the container and the lifting equipment. Thus, a vibration absorbing material impregnated with metallic elements is within the scope of this invention as would be a laminate construction of metallic and non-metallic strips. Alternatives to UHMW polyethylene include hard rubber, polytetrafluoroethylene (PTFE), or any other durable and vibration absorbing material. Vibration absorbing properties and wear resistance are the most significant design parameters for selecting a suitable material. Consequently, most resilient yet durable materials are considered to be suitable for use. Moreover, materials capable of plastic deformation are desired for reasons set forth above.

Overall, the container according to principles of the present invention is a quiet, lightweight, rust-proof, water-proof, graffiti resistant, dent resistant, strong and durable container that includes UV resistant materials to prevent damage from sunlight. Further, according to aspects of the invention, the containers are 100% recyclable and can be produced with up to 20% recycled resins.

In all embodiments, the internal and external surface characteristics may be other than smooth. Thus, the internal surface of the container or sleeve, or the external surface of the container or sleeve may have a ribbed character to for example, enhance the friction fit between these components and a fork or container pocket, respectively. Similarly, other interior or exterior surfaces may be ribbed.

The method of constructing the container is largely a design consideration. Examples of construction methods include rotational molding, clam molding, blow molding and extrusion molding.

In selected applications, the lid may not be present at all or may be merely a fabric cover designed to roll over the opening of the container to retain the refuse from blowing out of the container. Thus, the lid need not be in present in order for the invention to function as desired.

The pocket or sleeve 113 may also include a properly oriented liner. The liner may be inserted into pockets of the container. Each pocket 113 will have a progressive cross-sectional profile that may or may not vary over its length. In order to have a frictional fit between a pocket and a liner, the liner should have an outer complementary progressive cross-sectional profile. The liner is preferably constructed from 0.375 inch UHMW polyethylene. Another feature of liner is a bumper. Not only is vibration and hence noise produced by a fork interacting with a pocket, but also when the container abruptly contacts a fork support assembly. To this end, the bumper creates a barrier between the container around the inlet of each pocket.

The above description of illustrated embodiments of the invention is not intended to be exhaustive or to limit the invention to the precise form disclosed. While specific embodiments of, and examples for, the invention are described herein for illustrative purposes, equivalent modifications are possible within the scope of the invention, as those skilled within the relevant art will recognize. The teachings provided herein of the invention can be applied to other container systems, not necessary the exemplary containers described above. The various embodiments described above can be combined to provide further embodiments.

For example, the liner embodiment of the invention is formed to have outer dimensions that are sufficient to frictionally fit, with or without additional treatment, within the container pocket, and internal dimensions sufficient to receive an intended lifting fork, with or without a glove. Thus a cylinder of material is formed by, for example extrusion or rotational molding, to specifically fit a given container pocket.

A feature of the liner is the presence of a lip that extends laterally beyond the cylinder at an end to prevent the liner from exiting the container pocket if pushed by an entering fork. Another feature of the invention is the presence of a bumper that extends unidirectionally from the cylinder at the lip. The bumper serves to insulate the container structure from any lifting fork supporting structure such as a cross member or similar element.

The following discussion is presented to enable a person skilled in the art to make and use the invention. Various modifications to the preferred embodiment will be readily apparent to those skilled in the art, and the generic principles herein may be applied to other embodiments and applications without departing from the spirit and scope of the present invention as defined by the appended claims. Thus, the present invention is not intended to be limited to the embodiment shown, but is to be accorded the widest scope consistent with the principles and features disclosed herein.

In the following description, certain specific details are set forth in order to provide a thorough understanding of various embodiments of the invention. However, one skilled in the relevant art will recognize that the invention may be practiced without one or more of these specific details, or with other methods, components, materials, etc. In other instances, well-known structures associated with refuse containers have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the claimed invention.

The invention is directed toward a new commercial sized refuse container that reduces noise while having a high strength to weight ratio, for example, a rotationally-molded polyethylene container body. The container body of the present invention combines strength, durability and light weight in a container that is nearly maintenance free. The containers are stackable for saving shipping costs and for space-efficient storage.

The containers may be made of linear low-density polyethylene (LLDPE) with a unique structural configuration to provide a low maintenance, noise-dampening, impact and dent resistant, durable, strong and rust proof container. According to aspects of the invention, the addition of recessed panels or corrugations to the sides of the container may provide additional structural strength. According to further aspects of the invention, the bottom of the container may include strengthening bars positioned within molded grooves to provide an additionally reinforced bottom panel of the container. According to further aspects of the invention, a nut may be molded in place during the rotational molding process to allow the caster plates to be affixed thereto, thus providing an integral leak-proof connection for wheels affixed to the container.

The above description of illustrated embodiments, including what is described in the Abstract, is not intended to be exhaustive or to limit the invention to the precise forms disclosed. Although specific embodiments of and examples are described herein for illustrative purposes, various equivalent modifications can be made without departing from the spirit and scope of the invention, as will be recognized by those skilled in the relevant art. The teachings provided herein of the invention can be applied to containers generally, not necessarily the exemplary commercial refuse containers generally described above.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the invention can be modified, if necessary, to employ systems, circuits and concepts of the various patents, applications and publications to provide yet further embodiments of the invention.

These and other changes can be made to the invention in light of the above-detailed description. In general, in the following claims, the terms used should not be construed to limit the invention to the specific embodiments disclosed in the specification and the claims, but should be construed to include all materials and container configurations that operated in accordance with the claims. Accordingly, the invention is not limited by the disclosure, but instead its scope is to be determined entirely by the following claims.

What is claimed:

1. A commercial sized refuse container, comprising:
a container body made from vibration absorbing material and having a bottom, upstanding sidewalls extending from a perimeter of the bottom to define an interior cavity, the sidewall terminating in an upper edge to define an opening into the interior cavity, the bottom further comprising strengthening elements, integrally formed therein.

2. The commercial sized refuse container of claim 1, wherein the vibration absorbing material is a linear low-density polyethylene (LLDPE).

3. The commercial sized refuse container of claim 1, wherein the vibration absorbing material is a cross-linked polyethylene.

4. The commercial sized refuse container of claim 1, wherein the strengthening element is a pocket configured to receive a strengthening insert.

5. The commercial sized refuse container of claim 4, wherein the strengthening insert is made of metal.

6. The commercial sized refuse container of claim 4, wherein the strengthening insert is made of polyethylene.

7. The commercial sized refuse container of claim 1, wherein the strengthening element is a thickened portion of the vibration absorbing material integrally formed with the container.

8. The commercial sized refuse container of claim 1, wherein the sides include at least one of a corrugation.

9. The commercial sized refuse container of claim 1 further comprising a lid.

10. The commercial sized refuse container of claim 10 wherein the lid is hingedly affixed to the container along one side.

11. The commercial sized refuse container of claim 10 wherein the lid has corrugations therein.

12. The commercial sized refuse container of claim 10 wherein the lid is shaped in an inverted V shape.

13. The commercial sized refuse container of claim 10 further comprising a handle on the lid.

14. The commercial sized refuse container of claim 1 further comprising a lug integrally formed in the bottom of the container sized to receive a wheel assembly.

15. The commercial sized refuse container of claim 1 further comprising lifting pockets affixed to opposite sides of the container body, the lifting pocking having a vibration absorbing liner insert contained within the pocket to further mitigate noise when unloading the container.

16. A refuse container body rotationally molded from vibration absorbing material having a bottom, sidewalls extending upward from a perimeter of the bottom to define an interior cavity, the sidewall terminating in an upper edge forming a collar and defining an opening into a interior cavity of the container body, lifting pockets contained on an exterior of the container body for unloading the container, the lifting pockets made from vibration absorbing material and formed integrally with the rotational molding of the container body.

17. The refuse container body of claim 16, wherein the vibration absorbing material is a ultra high molecular weight (UHMW) polyethylene.

18. The refuse container body of claim 16, wherein the sidewalls include at least one of a corrugation.

19. The refuse container body of claim 16 further comprising a lug integrally formed in the bottom of the container sized to receive a wheel assembly.
